(19) United States
(12) Patent Application Publication
(10) Pub. No.: US 2015/0237378 A1
(43) Pub. Date: Aug. 20, 2015

(54) METHOD FOR CONTROLLING SAMPLE ADAPTIVE OFFSET FILTERING APPLIED TO DIFFERENT PARTIAL REGIONS IN ONE FRAME BASED ON DIFFERENT WEIGHTING PARAMETERS AND RELATED SAMPLE ADAPTIVE OFFSET FILTER

(71) Applicant: MEDIATEK INC., Hsin-Chu (TW)

(72) Inventors: Tung-Hsing Wu, Chiayi City (TW); Kun-Bin Lee, Taipei City (TW); Yi-Hsin Huang, Taoyuan City (TW)

(21) Appl. No.: 14/619,081

(22) Filed: Feb. 11, 2015

Related U.S. Application Data
(60) Provisional application No. 61/942,334, filed on Feb. 20, 2014.

(51) Int. Cl. H04N 19/80; H04N 19/172; H04N 19/126

(52) U.S. Cl. CPC H04N 19/80; H04N 19/126; H04N 19/172

(57) ABSTRACT

A method for controlling sample adaptive offset (SAO) filtering includes: generating a first SAO decision for pixels in a first partial region of a first frame based at least partly on a cost function that uses a first weighting parameter; and generating a second SAO decision for pixels in a second partial region of the first frame based at least partly on the cost function that uses a second weighting parameter. The second partial region is different from the first partial region, and the second weighting parameter is different from the first weighting parameter.

### CROSS REFERENCE TO RELATED APPLICATIONS

This application claims the benefit of U.S. provisional application No. 61/942,334, filed on Feb. 20, 2014 and incorporated herein by reference.

### BACKGROUND

The present invention relates to sample adaptive offset (SAO) filtering, and more particularly, to a method for controlling the SAO filtering applied to different partial regions in one frame based on different weighting parameters and a related SAO filter.

The conventional video coding standards generally adopt a block based (or coding unit based) coding technique to exploit spatial redundancy. For example, the basic approach is to divide the whole source image into a plurality of blocks (coding units), perform prediction on each block (coding unit), transform residues of each block (coding unit), and perform quantization and entropy encoding. Besides, a reconstructed frame is generated in a coding loop to provide reference pixel data used for coding following blocks (coding units). For certain video coding standards, in-loop filter(s) may be used for enhancing the image quality of the reconstructed frame. For example, a deblocking filter is included in an H.264 coding loop, and a deblocking filter and a sample adaptive offset (SAO) filter are both included in an HEVC (High Efficiency Video Coding) coding loop.

With regard to the SAO filter, it is used to reduce undesirable visual artifacts as well as the mean distortion between original and reconstructed samples. In general, SAO is applied to reconstructed samples after application of deblocking is done. The SAO filter may add an offset to a reconstructed sample, where the value of the offset depends on the local characteristics of the reconstructed sample, such as edge direction/shape and/or intensity level. There are three SAO types, including Band Offset (BO), Edge Offset (EO), and OFF (i.e., SAO not applied). With regard to BO, there are 32 possible band-offset SAO parameters each having 4 offsets corresponding to 4 consecutive bands. With regard to EO, there are 4 possible edge-offset SAO parameters each having 4 offsets corresponding to 4 edge shapes. When the selected SAO type is OFF (i.e., SAO not applied), the SAO parameter includes the SAO type only. When the selected SAO type is EO or BO, the SAO parameter includes the SAO type and the offsets.

For pixels in each largest coding unit (LCU) of a reconstructed frame, one type of the SAO filter is applied based on an SAO decision. The encoder divides the reconstructed frame into a plurality of LCUs, and decides which of the SAO types is to be used for each of the LCUs. For example, the SAO filter collects statistic data of all SAO types for one LCU, derives corresponding offsets for each SAO parameter, collects all SAO parameters for each SAO type, and selects the best SAO type and parameter based on an SAO decision.

If the SAO decision for each LCU in the same reconstructed frame is inaccurate, the coding efficiency would be worse. Hence, there is a need for an innovative SAO decision design which is capable of generating a more accurate SAO decision for each LCU in the same reconstructed frame to thereby improving the coding efficiency.

### SUMMARY

One of the objectives of the claimed invention is to provide a method for controlling the SAO filtering applied to different partial regions in one frame based on different weighting parameters and a related SAO filter.

According to a first aspect of the present invention, an exemplary method for controlling sample adaptive offset (SAO) filtering is disclosed. The exemplary method includes: generating a first SAO decision for pixels in a first partial region of a first frame based at least partly on a cost function that uses a first weighting parameter; and generating a second SAO decision for pixels in a second partial region of the first frame based at least partly on the cost function that uses a second weighting parameter, wherein the second partial region is different from the first partial region, and the second weighting parameter is different from the first weighting parameter.

According to a second aspect of the present invention, an exemplary method for controlling sample adaptive offset (SAO) filtering is disclosed. The exemplary method includes: deriving a specific quantization parameter (QP) from at least one quantization parameter used for encoding pixels in a source frame; determining a weighting parameter according to the specific quantization parameter; and generating an SAO decision for pixels in a specific partial region of a first frame based at least partly on a cost function that uses the weighting parameter, wherein the first frame is a reconstructed frame corresponding to the source frame.

According to a third aspect of the present invention, an exemplary method for controlling sample adaptive offset (SAO) filtering is disclosed. The exemplary method includes: deriving a second weighting parameter from at least one first weighting parameter, wherein the at least one first weighting parameter is associated with encoding of pixels in a partial region of a source frame, and is received from a weighting parameter decision mechanism; and generating an SAO decision for pixels in a specific partial region of a first frame based at least partly on a cost function that uses the second weighting parameter, wherein the specific partial region of the first frame is a reconstructed partial region corresponding to the partial region of the source frame.

According to a fourth aspect of the present invention, an exemplary sample adaptive offset (SAO) filter is disclosed. The exemplary SAO filter includes a filter and a decision logic. The filter is configured to operate in response to each SAO decision. The decision logic is configured to generate a first SAO decision for pixels in a first partial region of a first frame based at least partly on a cost function that uses a first weighting parameter; and generate a second SAO decision for pixels in a second partial region of the first frame based at least partly on the cost function that uses a second weighting parameter, wherein the second partial region is different from the first partial region, and the second weighting parameter is different from the first weighting parameter.

According to a fifth aspect of the present invention, an exemplary sample adaptive offset (SAO) filter is disclosed. The exemplary SAO filter includes a filter and a decision logic. The filter is configured to operate in response to each SAO decision. The decision logic is configured to derive a specific quantization parameter (QP) from at least one quantization parameter used for encoding pixels in a source frame, determine a weighting parameter according to the specific quantization parameter, and generate an SAO decision for pixels in a specific partial region of a first frame based at least partly on a cost function that uses the weighting parameter, wherein the first frame is a reconstructed frame corresponding to the source frame.

According to a sixth aspect of the present invention, an exemplary sample adaptive offset (SAO) filter is disclosed. The exemplary SAO filter includes a filter and a decision logic. The filter is configured to operate in response to each SAO decision. The decision logic is configured to derive a second weighting parameter from at least one first weighting parameter, wherein the at least one first weighting parameter is associated with encoding of pixels in a partial region of a source frame, and is received from a weighting parameter decision mechanism. The decision logic is further configured to generate an SAO decision for pixels in a specific partial region of a first frame based at least partly on a cost function that uses the second weighting parameter, wherein the specific partial region of the first frame is a reconstructed partial region corresponding to the partial region of the source frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an encoder according to an embodiment of the present invention.

FIG. 2 is a flowchart illustrating a first method for controlling SAO filtering according to an embodiment of the present invention.

FIG. 3 is a diagram illustrating a first method of setting the specific quantization parameter for the specific partial region of the reconstructed frame according to an embodiment of the present invention.

FIG. 4 is a diagram illustrating a second method of setting the specific quantization parameter for the specific partial region of the reconstructed frame according to an embodiment of the present invention.

FIG. 5 is a diagram illustrating a third method of setting the specific quantization parameter for the specific partial region of the reconstructed frame according to an embodiment of the present invention.

FIG. 6 is a flowchart illustrating a second method for controlling SAO filtering according to an embodiment of the present invention.

FIG. 7 is a diagram illustrating a first method of setting a second weighting parameter for the specific partial region of the reconstructed frame according to an embodiment of the present invention.

FIG. 8 is a diagram illustrating a second method of setting a second weighting parameter for the specific partial region of the reconstructed frame according to an embodiment of the present invention.

FIG. 9 is a diagram illustrating a third method of setting a second weighting parameter for the specific partial region of the reconstructed frame according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

One concept of the present invention is to adaptively set weighting parameter values used by a cost function for generating SAO decisions for different partial regions in the same frame. For example, each partial region in the same frame includes one LCU, such that SAO decisions for different LCUs may be generated based on the cost function using different weighting parameters. Since the weighting parameter of the cost function used for making SAO decisions for different LCUs in a current frame is not set by a fixed value derived from a quantization parameter of a last coding unit in a previous frame, the SAO decisions of the LCUs in the current frame are more accurate, and SAO applied to the LCUs in the current frame based on the SAO decisions is capable of more effectively reducing the distortion between the original LCUs in the source frame and the reconstructed LCUs in the reconstructed frame to thereby improve the coding efficiency. In addition, the proposed SAO decision design is suitable for implementation that uses coding-unit pipeline, where the implementation can be a hardware-based implementation, a software-based implementation, or a hybrid implementation using both hardware and software. Further details of the proposed SAO decision design are described as below.

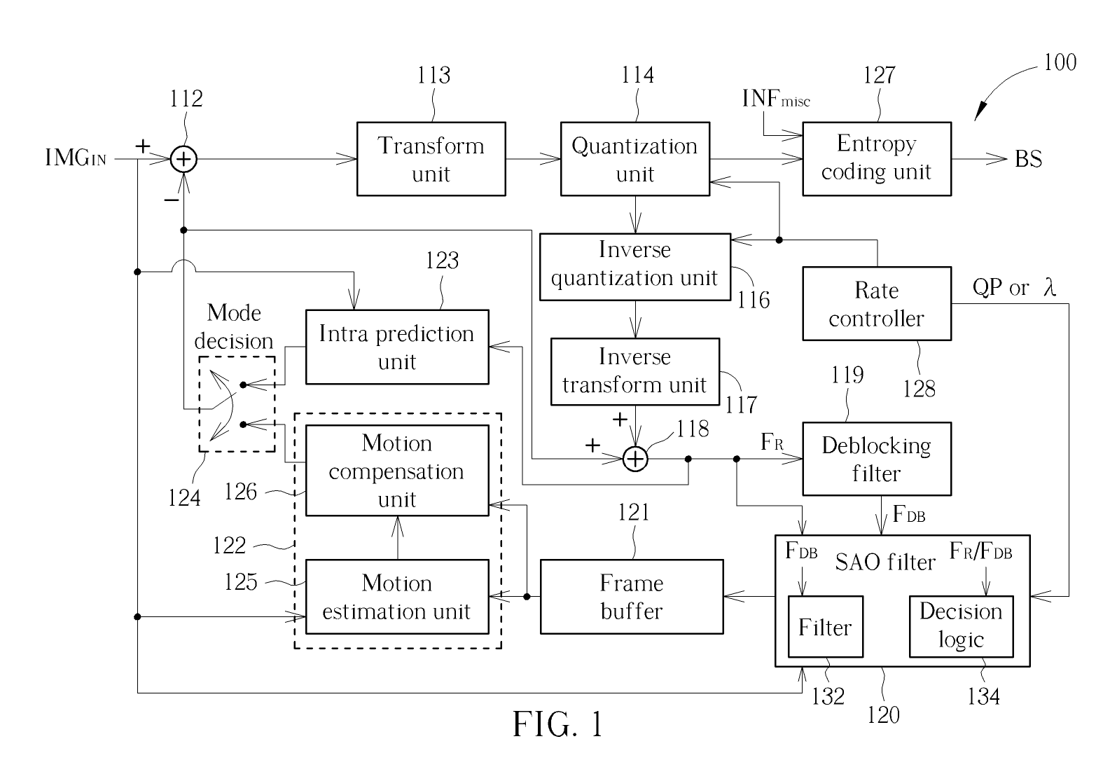

FIG. 1 is a block diagram illustrating an encoder according to an embodiment of the present invention. By way of example, but not limitation, the encoder 100 may be an HEVC encoder using the proposed SAO decision design. The encoder 100 is used to encode pixel data of a source frame IMG_{IN} to generate a bitstream BS carrying encoded frame information corresponding to the source frame IMG_{IN}. In this embodiment, the encoder 100 includes a coding loop composed of a residue generator (e.g., an adder configured to perform a subtraction operation) 112, a transform unit 113, a quantization unit 114, an inverse quantization unit 116, an inverse transform unit 117, a combiner (e.g., an adder configured to perform an addition operation) 118, a deblocking filter 119, a sample adaptive offset (SAO) filter 120, a frame buffer 121, an inter prediction unit 122, an intra prediction unit 123, and a mode decision unit 124 where the inter prediction unit 122 includes a motion estimation unit 125 and a motion compensation unit 126. In addition to the coding loop, the encoder 100 further has an entropy coding unit 127 arranged to generate the bitstream BS by performing entropy encoding upon quantized coefficients generated from the quantization unit 114 and miscellaneous information INF_{misc} generated from other circuit components of the encoder 100. For example, the miscellaneous information INF_{misc} may include quantization information (e.g., quantization parameter), inter/intra prediction information, SAO information (e.g., SAO parameter), etc.

The architecture of the encoder 100 may be configured based on any conventional video encoding architecture. The major difference is that the SAO filter 120 is configured to employ the proposed SAO decision design different from the conventional SAO decision design. As a person skilled in the pertinent art should readily understand fundamental operations of other circuit components included in the encoder 100, further description of these circuit components is omitted here for brevity. With regard to the SAO filter 120, further details are described as below.

As known to those skilled in the pertinent art, the rate controller 128 is used to apply rate control to the encoding pixel data according to bit budget allocation. In this embodiment, the information used for controlling the bit rate of the encoded pixel data is also referenced by the SAO filter 120 to adaptively set weighting parameter values used by a cost function for generating SAO decisions for different partial regions (e.g., different LCUs) in the same frame. Hence, the SAO filter 120 is coupled to the rate controller 128, and configured to receive quantization parameters QP from the rate controller 128 if the rate controller 128 performs quantization parameter based rate control, or derive weighting parameters λ from weighting parameter information given by a weighting parameter decision mechanism (e.g., the rate controller 128) if the rate controller 128 performs weighting parameter based rate control. For example, when the rate controller 128 performs quantization parameter based rate control, the rate controller 128 finds a quantization parameter for each coding unit to control the bit rate. For another example, when the rate controller 128 performs weighting parameter based rate control and the weighting parameter decision mechanism is implemented in the rate controller 128, the rate controller 128 finds a weighting parameter for each coding unit to control the bit rate, where the selected weighting parameter is mapped to a quantization parameter used by the quantization unit 114 and inverse quantization unit 116. By way of example, but not limitation, the cost function used by the SAO filter 120 may be a rate-distortion cost function, and the weighting parameter λ may be a Lagrange multiplier of the rate-distortion cost function.

As shown in FIG. 1, the SAO filter 120 includes a filter 132 and a decision logic 134. The filter 132 is configured to operate in response to each SAO decision generated from the decision logic 134 for a partial region (e.g., one LCU) in a current frame. In one exemplary design, the current frame may be a residue reconstructed frame F_{R} generated by the combiner 118. For example, the decision logic 134 may generate an SAO decision for one LCU based on statistic data derived from pixel data of the original LCU in the source frame IMG_{IN} and pixel data of the reconstructed LCU in the residue reconstructed frame F_{R}. In another exemplary design, the current frame may be a reconstructed frame already processed by the deblocking filter 119, i.e., a deblocked reconstructed frame F_{DB} generated by the deblocking filter 119. For example, the decision logic 134 may generate an SAO decision for one LCU based on statistic data derived from pixel data of the original LCU in the source frame IMG_{IN} and pixel data of the deblocked reconstructed LCU in the deblocked reconstructed frame F_{DB}. The filter 132 may apply SAO to pixel data of LCUs in the deblocked reconstructed frame F_{DB} according to corresponding SAO decisions generated from the decision logic 134. For example, the aforementioned pixel data may include luminance data only. For another example, the aforementioned pixel data may include chrominance data only. For yet another example, the aforementioned pixel data may include luminance data and chrominance data.

The decision logic 134 is configured to generate an SAO decision that selects an SAO type and parameter for a partial region of a current frame (e.g., one LCU of the deblocked reconstructed frame F_{DB}). For example, the decision logic 134 collects statistic data of all SAO types for one LCU, derives corresponding offsets for SAO parameters, collects all SAO parameters for each SAO type, and selects the best SAO type and parameter with a lowest cost value. In this embodiment, the cost function used by the decision logic 134 may be a rate-distortion cost function J=D+λ×R, where J is the rate-distortion cost, D is the pixel distortion after an SAO parameter of an SAO type is applied, R represents the number of bits required for encoding the SAO parameter of the SAO type, and λ stands for the Lagrange multiplier. Hence, the decision logic 134 would compute rate-distortion cost values for SAO parameters of all SAO types, and generate an SAO decision based on the lowest rate-distortion cost value.

It should be noted that the present invention focuses on adaptively setting the weighting parameter values (e.g., λ values) for different partial regions (e.g., LCUs) in the current frame, and has no limitations on how to select the best SAO type and parameter based on a rate-distortion cost function. Further details directed to using the rate-distortion cost function to generate an SAO decision is omitted here for brevity.

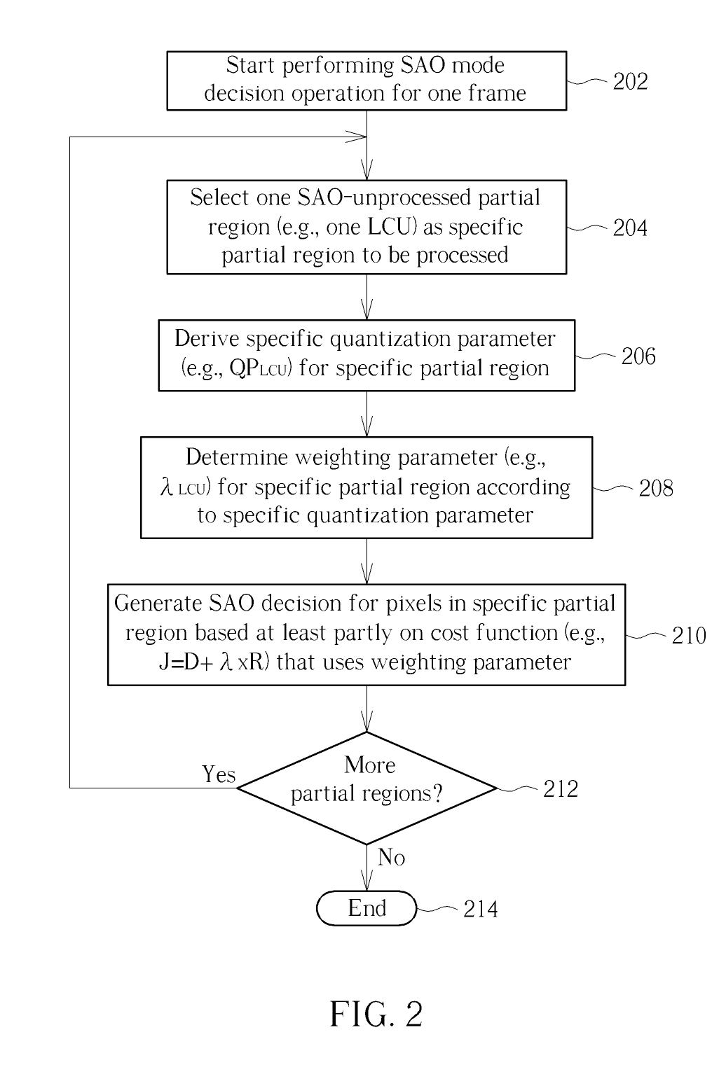

FIG. 2 is a flowchart illustrating a first method for controlling SAO filtering according to an embodiment of the present invention. Provided that the result is substantially the same, the steps are not required to be executed in the exact order shown in FIG. 2. The method may be employed by the decision logic 134 of the SAO filter 120, and may be briefly summarized as below.

Step 202: Start performing an SAO mode decision operation upon a reconstructed frame (e.g., F_{R} or F_{DB}), wherein the reconstructed frame corresponds to a source frame.

Step 204: Select one SAO-unprocessed partial region (e.g., one LCU) of the reconstructed frame as a specific partial region to be processed.

Step 206: Derive a specific quantization parameter (e.g., QP_{LCU}) for the specific partial region from at least one quantization parameter used for encoding pixels in the source frame.

Step 208: Determine a weighting parameter (e.g., λ_{LCU}) for the specific partial region according to the specific quantization parameter.

Step 210: Generate an SAO decision for pixels in the specific partial region of the reconstructed frame based at least partly on a cost function (e.g., J=D+λ×R) that uses the weighting parameter.

Step 212: Check if the reconstructed frame has partial region(s) not SAO-processed yet. If yes, go to step 204; otherwise, go to step 214.

Step 214: End.

In this embodiment, the rate controller 128 performs quantization parameter based rate control. Hence, concerning one partial region in the reconstructed frame (e.g., F_{R} or F_{DB}), the decision logic 134 receives quantization parameter information from the rate controller 128, and determines a weighting parameter used in a cost function based on a quantization parameter derived from the received quantization parameter information (steps 206 and 208). When a partial region of the reconstructed frame (e.g., F_{R} or F_{DB}) is one LCU, a co-located LCU in the corresponding source frame (e.g., IMG_{IN}) may be divided into smaller CUs for encoding or may be directly used for encoding. Hence, the specific quantization parameter for the specific partial region may be derived from one or more quantization parameters given by the rate controller 128.

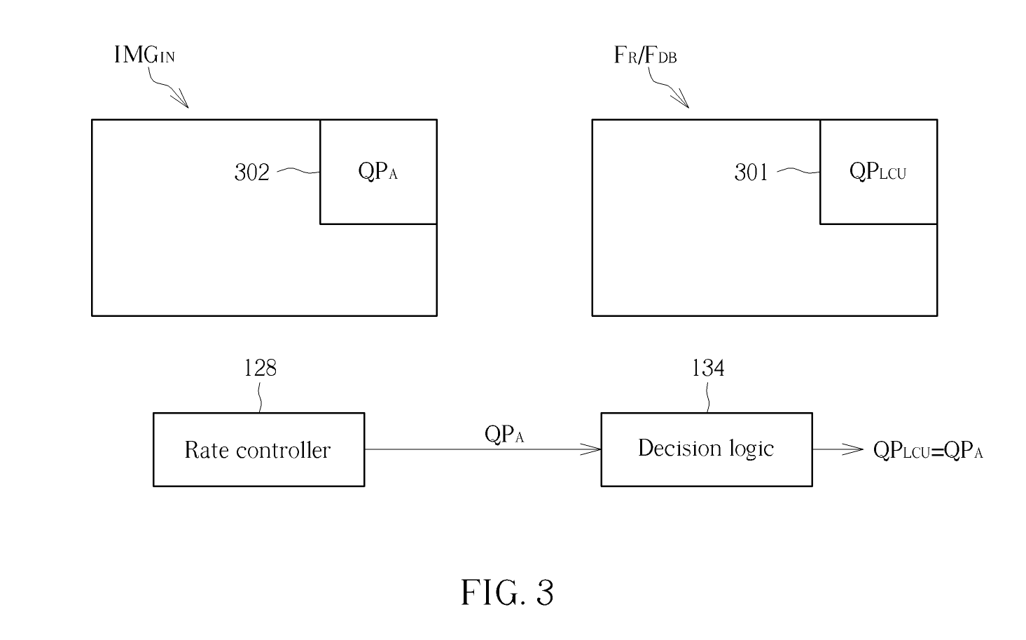

In a first exemplary embodiment, the decision logic 134 sets the specific quantization parameter (e.g., QP_{LCU} by a quantization parameter (e.g., QP_{A}) used for encoding all of a partial region (e.g., a co-located LCU) of the source frame, wherein the specific partial region of the reconstructed frame is a reconstructed partial region corresponding to the partial region of the source frame. Please refer to FIG. 3, which is a diagram illustrating a first method of setting the specific quantization parameter for the specific partial region of the reconstructed frame according to an embodiment of the present invention. In this example, the reconstructed frame used by the decision logic 134 may be the residue reconstructed frame F_{R} generated from the combiner 118 or the deblocked reconstructed frame F_{DB} generated from the deblocking filter 119. In addition, the specific partial region selected in step 204 may be an LCU 301 that is a reconstructed LCU corresponding to a co-located original LCU 302 in the source frame IMG_{IN}. The original LCU 302 is assigned single quantization parameter QP_{A} by the rate controller 128 for encoding all of the original LCU 302. Hence, the decision logic 134 receives the single quantization parameter QP_{A} from the rate controller 128, and sets the specific quantization parameter QP_{LCU} involved in making an SAO decision for the reconstructed LCU 301 by the quantization parameter QP_{A} (i.e., QP_{LCU}=QP_{A}).

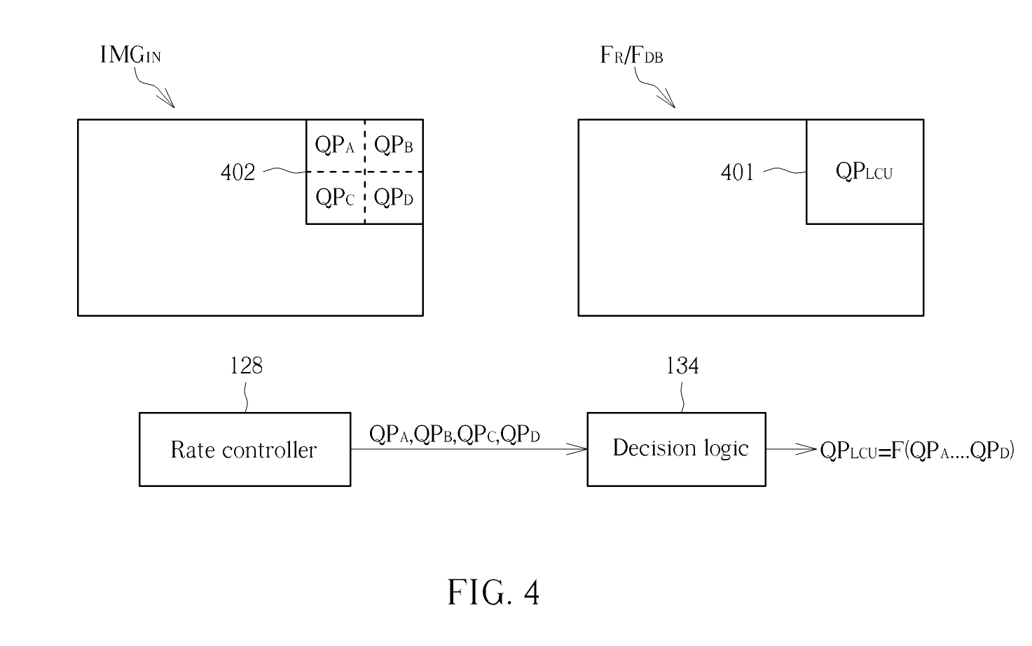

In a second exemplary embodiment, the decision logic 134 sets the specific quantization parameter (e.g., QP_{LCU}) by performing a QP selection operation F upon a plurality of quantization parameters (e.g., QP_{A}, QP_{B}, QP_{C}, QP_{D}), each used for encoding a portion of a partial region (e.g., a co-located LCU) of the source frame, wherein the specific partial region is a reconstructed partial region corresponding to the partial region of the source frame. Please refer to FIG. 4, which is a diagram illustrating a second method of setting the specific quantization parameter for the specific partial region of the reconstructed frame according to an embodiment of the present invention. In this example, the reconstructed frame used by the decision logic 134 may be the residue reconstructed frame F_{R} generated from the combiner 118 or the deblocked reconstructed frame F_{DB} generated from the deblocking filter 119. In addition, the specific partial region selected in step 204 may be an LCU 401 that is a reconstructed LCU corresponding to a co-located original LCU 402 in the source frame IMG_{IN}. In this example, the original LCU 402 is assigned four quantization parameters QP_{A}, QP_{B}, QP_{C}, QP_{B} by the rate controller 128 for encoding four CUs in the original LCU 302, respectively. Hence, the decision logic 134 receives the quantization parameters QP_{A}, QP_{B}, QP_{C}, QP_{B} from the rate controller 128, and sets the specific quantization parameter QP_{LCU} involved in making an SAO decision for the reconstructed LCU 301 by performing the QP selection operation F upon the quantization parameters QP_{A}, QP_{B}, QP_{C}, QP_{B}, i.e., QP_{LCU}=F(QP_{A}, QP_{B}, QP_{C}, QP_{D}). By way of example, but not limitation, the QP selection operation F may include an arithmetic operation, wherein the arithmetic operation includes at least one of an addition operation, a subtraction operation, a maximum operation, a minimum operation, a mean operation, and a median operation.

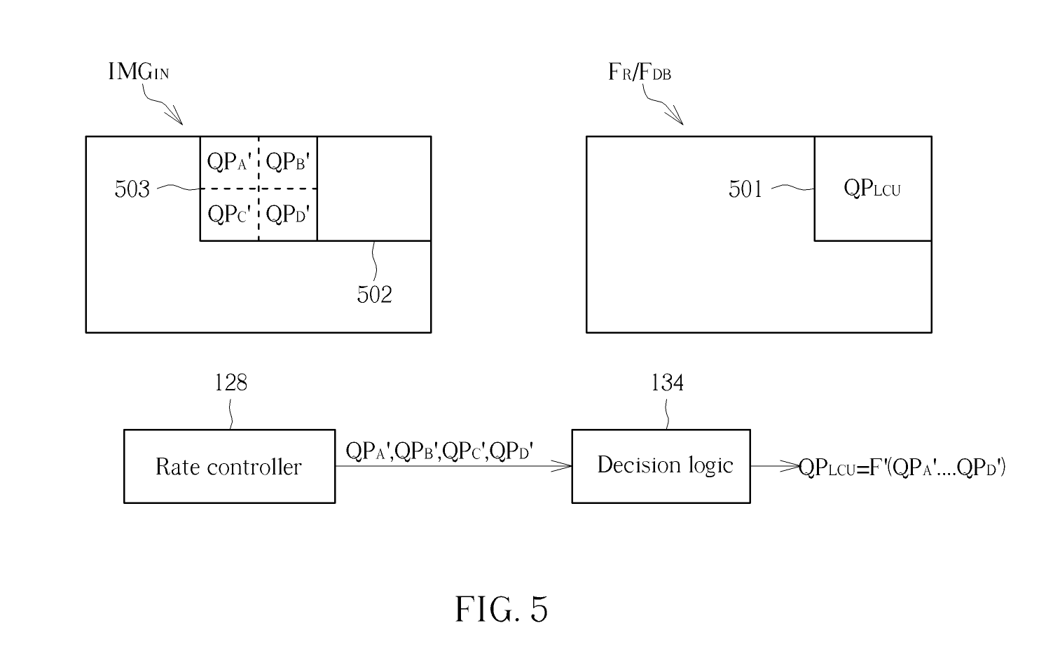

In a third exemplary embodiment, the decision logic 134 sets the specific quantization parameter (e.g., QP_{LCU}) by performing an QP selection operation F′ upon a plurality of quantization parameters (e.g., QP_{A}′, QP_{B}′, QP_{C}′, QP_{D}′), each used for encoding a portion of a partial region of the source frame, wherein the specific partial region of the reconstructed frame is a reconstructed partial region corresponding to another partial region (e.g., a co-located LCU) of the source frame that is adjacent to the partial region of the source frame. Please refer to FIG. 5, which is a diagram illustrating a third method of setting the specific quantization parameter for the specific partial region of the reconstructed frame according to an embodiment of the present invention. In this example, the reconstructed frame used by the decision logic 134 may be the residue reconstructed frame F_{R} generated from the combiner 118 or the deblocked reconstructed frame F_{DB} generated from the deblocking filter 119. In addition, the specific partial region selected in step 204 may be an LCU 501 that is a reconstructed LCU corresponding to a co-located original LCU 502 in the source frame IMG_{IN}. As shown in FIG. 5, the original LCU 503 in the source frame IMG_{IN} is adjacent to the original LCU 502 in the source frame IMG_{IN}. More specifically, encoding of the original LCU 502 is started after the original LCU 503 has been encoded. In this example, the original LCU 503 is located on the left side of the original LCU 502. However, this is for illustrative purposes only, and is not meant to be a limitation of the present invention. The original LCU 503 is assigned four quantization parameter QP_{A}′, QP_{B}′, QP_{C}′, QP_{D}′ by the rate controller 128 for encoding four CUs in the original LCU 503, respectively. The decision logic 134 receives the quantization parameters QP_{A}′, QP_{B}′, QP_{C}′, QP_{D}′ from the rate controller 128, and sets the specific quantization parameter QP_{LCU} involved in making an SAO decision for the reconstructed LCU 501 by performing the QP selection operation F′ upon the quantization parameters QP_{A}′, QP_{B}′, QP_{C}′, QP_{D}′, i.e., QP_{LCU}=F′(QP_{A}′, QP_{B}′, QP_{C}′, QP_{D}′) By way of example, but not limitation, the QP selection operation F′ includes an arithmetic operation, wherein the arithmetic operation may include at least one of an addition operation, a subtraction operation, a maximum operation, a minimum operation, a mean operation, and a median operation.

After the specific quantization parameter (e.g., QP_{LCU}) for the specific partial region is obtained in step 206, the decision logic 134 determines the weighting parameter (e.g., λ_{LCU}) for the specific partial region according to the specific quantization parameter (e.g., QP_{LCU}). For example, look-up tables for different frame types (e.g., intra frame type, predictive frame type, and bi-directional predictive frame type) are created and stored in a storage device (not shown in FIG. 1) accessible to the decision logic 134, where each look-up table records a plurality of quantization parameter values mapped to a plurality of weighting parameter values. That is, each look-up table may record pre-defined mapping relationship between quantization parameter values and weighting parameter values. Hence, the decision logic 134 can refer to the specific quantization parameter (e.g., QP_{LCU}) to search a look-up table corresponding to the frame type of the source frame IMG_{IN} for the mapped weighting parameter (e.g., λ_{LCU}). However, this is for illustrative purposes only, and is not meant to be a limitation of the present invention. Any means capable of deriving the weighting parameter (e.g., λ_{LCU}) from the specific quantization parameter (e.g., QP_{LCU}) can be employed by the decision logic 134. For example, the decision logic 134 may derive the weighting parameter from performing computation based on the specific quantization parameter.

After the weighting parameter (e.g., λ_{LCU}) is determined, the decision logic 134 can use a cost function with the determined weighting parameter (e.g., J=D+λ_{LCU}×R) to find the best SAO type and parameter with the lowest cost value, thus generating an SAO decision for pixels in the specific partial region of the reconstructed frame (step 210).

In a case where the reconstructed frame used by the decision logic 134 is the residue reconstructed frame F_{R} generated from the combiner 118, the filter 132 may apply SAO to a co-located partial region (e.g., a co-located LCU) in the deblocked reconstructed frame F_{DB} according to the best SAO type and parameter indicated by the SAO decision. In another case where the reconstructed frame used by the decision logic 134 is the deblocked reconstructed frame F_{DB} generated from the deblocking filter 119, the filter 132 may apply SAO to the specific partial region (e.g., LCU 301/401/501) in the deblocked reconstructed frame F_{DB} according to the best SAO type and parameter indicated by the SAO decision.

The decision logic 134 performs steps 204-210 for each partial region (e.g., each LCU) in the reconstructed frame (e.g., F_{R} or F_{DB}) to generate an SAO decision, until SAO decisions for all partial regions (e.g., all LCUs) in the reconstructed frame (e.g., F_{R} or F_{DB}) have been generated (step 212).

Since the SAO decisions generated for different partial regions in the same frame are not based on a fixed weighting parameter, the decision logic 134 may generate a first SAO decision for pixels in a first partial region of a frame based at least partly on a cost function that uses a first weighting parameter derived from a first quantization parameter (e.g., a rate-distortion cost function that uses a Lagrange multiplier set by a first value), and generate a second SAO decision for pixels in a second partial region of the frame based at least partly on the cost function that uses a second weighting parameter derived from a second quantization parameter (e.g., the rate-distortion cost function that uses the Lagrange multiplier set by a second value different from the first value), where the second partial region is different from the first partial region, the second quantization parameter is different from the first quantization parameter, and the second weighting parameter is different from the first weighting parameter. To put it simply, when the encoder 100 encodes pixel data of different LCUs in one source frame by using different quantization parameters, the Lagrange multiplier in the rate-distortion cost function used for making SAO decisions are modified in response to the different quantization parameters. Hence, the coding efficiency can be improved due to reduced distortion between the original samples and the reconstructed samples.

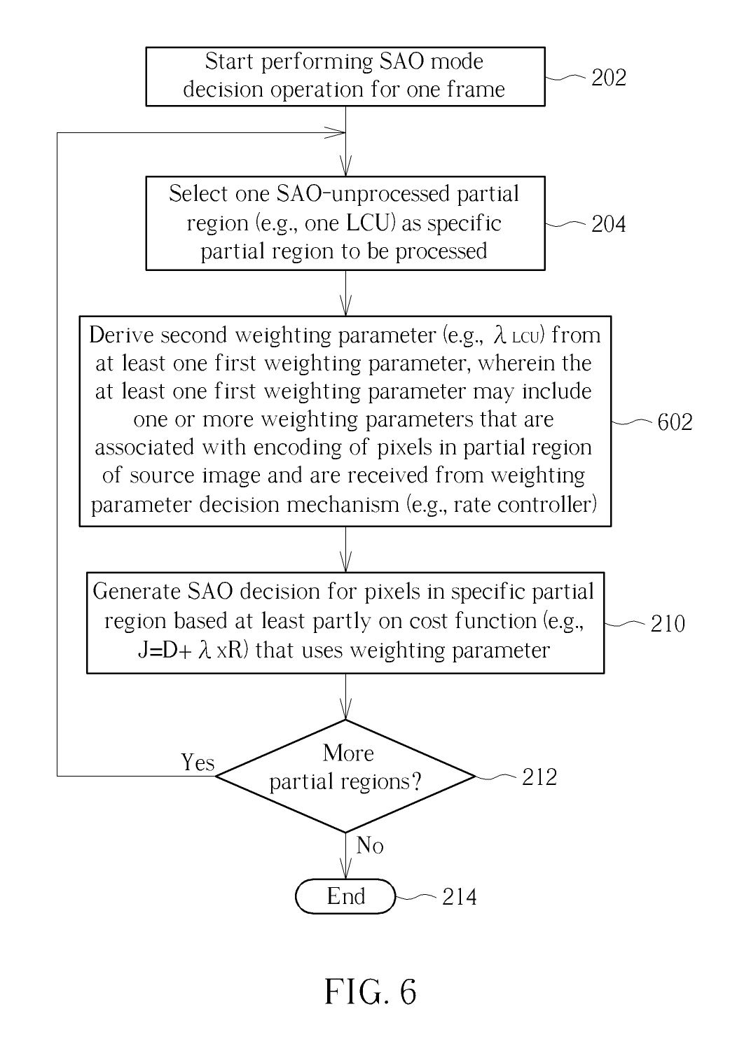

FIG. 6 is a flowchart illustrating a second method for controlling SAO filtering according to an embodiment of the present invention. Provided that the result is substantially the same, the steps are not required to be executed in the exact order shown in FIG. 6. The method may be employed by the decision logic 134 of the SAO filter 120. The major difference between the first method shown in FIG. 2 and the second method shown in FIG. 6 is that steps 206 and 208 are replaced by step 602 as below.

Step 602: Derive a second weighting parameter (e.g., λ_{LCU}) from at least one first weighting parameter. The at least one first weighting parameter may include one or more weighting parameters that are associated with encoding (e.g., rate control) of pixels in a partial region of a source image and are received from a weighting parameter decision mechanism (e.g., rate controller 128). In addition, the specific partial region may be a reconstructed partial region corresponding to the partial region of the source frame.

In this embodiment, the rate controller 128 performs weighting parameter based rate control. Byway of example, but not limitation, a weighting parameter decision mechanism may be implemented in the rate controller 128. Hence, concerning one partial region (e.g., one LCU) in the reconstructed frame, the decision logic 134 can derive a needed second weighting parameter (e.g., λ_{LCU} from weighting parameter information (e.g., one or more first weighting parameters) given by the rate controller 128 without further quantization parameter manipulation, where the derived second weighting parameter is used in a cost function (e.g., J=D+λ_{LCU}×R) for generating an SAO decision for the partial region in the reconstructed frame.

In this embodiment, the rate controller 128 performs weighting parameter based rate control. Hence, concerning one partial region in the reconstructed frame (e.g., F_{R} or F_{DB}), the decision logic 134 receives weighting parameter information (e.g., at least one first weighting parameter) from the rate controller 128, and determines a second weighting parameter used in a cost function based on the received weighting parameter information (step 602). When a partial region of the reconstructed frame (e.g., F_{R} or F_{DB}) is one LCU, a co-located LCU in the corresponding source frame (e.g., IMG_{IN}) may be divided into smaller CUs for encoding or may be directly used for encoding. Hence, the second weighting parameter for the specific partial region may be derived from one or more first weighting parameters given by the rate controller 128.

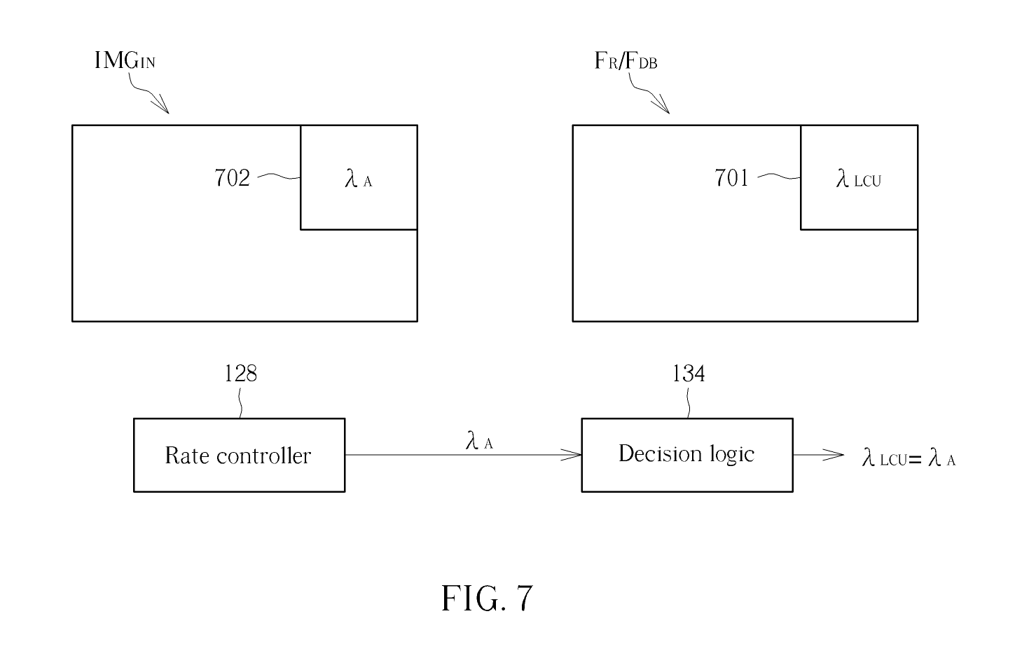

In a first exemplary embodiment, the decision logic 134 sets the second weighting parameter (e.g., λ_{LCU}) used for making an SAO decision by a first weighting parameter (e.g., λ_{A}) used for encoding (e.g., rate control) of all of a partial region (e.g., a co-located LCU) of the source frame, wherein the specific partial region is a reconstructed partial region corresponding to the partial region of the source frame. Please refer to FIG. 7, which is a diagram illustrating a first method of setting a second weighting parameter for the specific partial region of the reconstructed frame according to an embodiment of the present invention. In this example, the reconstructed frame used by the decision logic 134 may be the residue reconstructed frame F_{R} generated from the combiner 118 or the deblocked reconstructed frame F_{DB} generated from the deblocking filter 119. In addition, the specific partial region selected in step 204 may be an LCU 701 that is a reconstructed LCU corresponding to a co-located original LCU 702 in the source frame IMG_{IN}. The original LCU 702 is assigned a single first weighting parameter λ_{A} by the rate controller 128 for encoding (e.g., rate control) of all of the original LCU 702. Hence, the decision logic 134 receives the single first weighting parameter λ_{A} from the rate controller 128, and sets the second weighting parameter λ_{LCU} involved in making an SAO decision for the reconstructed LCU 701 by the received first weighting parameter λ_{A} (i.e., λ_{LCU}=λ_{A}).

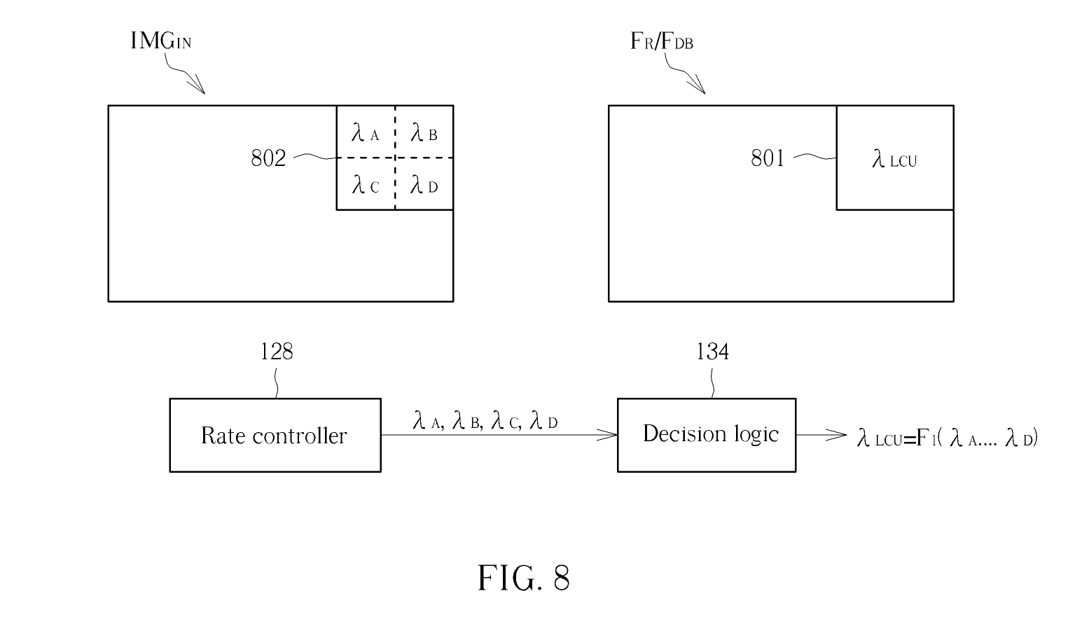

In a second exemplary embodiment, the decision logic 134 sets the second weighting parameter (e.g., λ_{LCU}) used for making an SAO decision by performing a λ selection operation F₁ upon a plurality of first weighting parameters (e.g. λ_{A}, λ_{B}, λ_{C}, λ_{D}), each used for encoding (e.g., rate control) of a portion of a partial region (e.g., a co-located LCU) of the source frame, wherein the specific partial region is a reconstructed partial region corresponding to the partial region of the source frame. Please refer to FIG. 8, which is a diagram illustrating a second method of setting a second weighting parameter for the specific partial region of the reconstructed frame according to an embodiment of the present invention. In this example, the reconstructed frame used by the decision logic 134 may be the residue reconstructed frame F_{R} generated from the combiner 118 or the deblocked reconstructed frame F_{DB} generated from the deblocking filter 119. In addition, the specific partial region selected in step 204 may be an LCU 801 that is a reconstructed LCU corresponding to a co-located original LCU 802 in the source frame IMG_{IN}. In this example, the original LCU 802 is assigned four first weighting parameters λ_{A}, λ_{B}, λ_{C}, λ_{D} by the rate controller 128 for encoding (e.g., rate control) of four CUs in the original LCU 802, respectively. Hence, the decision logic 134 receives the first weighting parameters λ_{A}, λ_{B}, λ_{C}, λ_{D} from the rate controller 128, and sets the second weighting parameter λ_{LCU} involved in making an SAO decision for the reconstructed LCU 801 by performing the λ selection operation F₁ upon the received first weighting parameters λ_{A}, λ_{B}, λ_{C}, λ_{D}, i.e., λ_{LCU}=F₁(λ_{A}, λ_{B}, λ_{C}, λ_{D}). By way of example, but not limitation, the λ selection operation F₁ includes an arithmetic operation, wherein the arithmetic operation may include at least one of an addition operation, a subtraction operation, a maximum operation, a minimum operation, a mean operation, and a median operation.

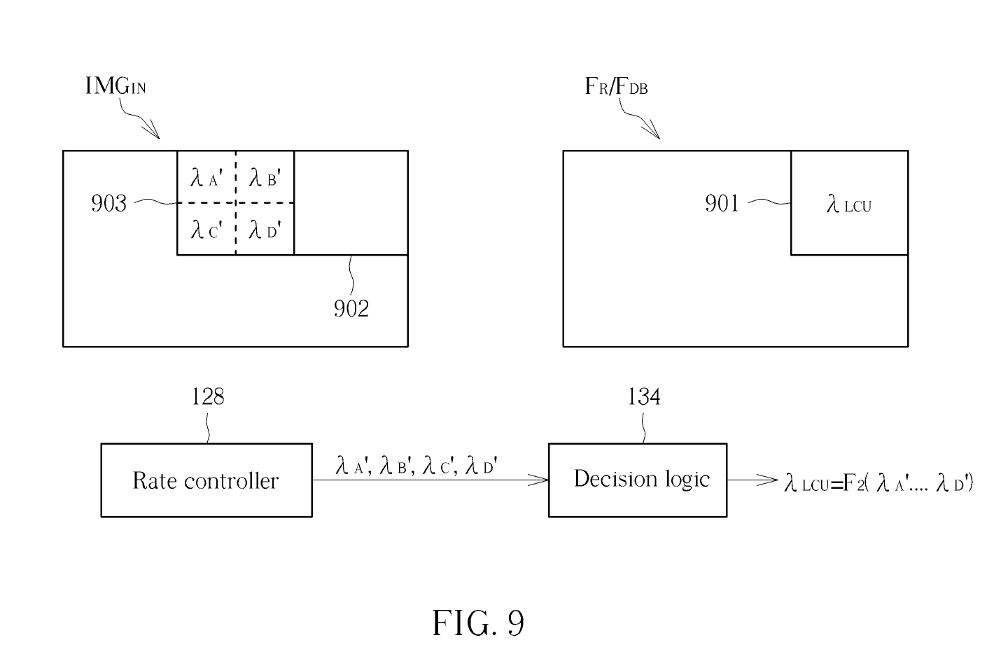

In a third exemplary embodiment, the decision logic 134 sets the second weighting parameter (e.g., λ_{LCU}) used for making an SAO decision by performing a λ selection operation F₂ upon a plurality of first weighting parameters (e.g. λ_{A}′, λ_{B}′, λ_{C}′, λ_{D}′), each used for encoding (e.g., rate control) of a portion of a partial region of the source frame, wherein the specific partial region is a reconstructed partial region corresponding to another partial region (e.g., a co-located LCU) of the source frame that is adjacent to the partial region of the source frame. Please refer to FIG. 9, which is a diagram illustrating a third method of setting a second weighting parameter for the specific partial region of the reconstructed frame according to an embodiment of the present invention. In this example, the reconstructed frame used by the decision logic 134 may be the residue reconstructed frame F_{R} generated from the combiner 118 or the deblocked reconstructed frame F_{DB} generated from the deblocking filter 119. In addition, the specific partial region selected in step 204 may be an LCU 901 that is a reconstructed LCU corresponding to a co-located original LCU 902 in the source frame IMG_{IN}. As shown in FIG. 9, the original LCU 903 in the source frame IMG_{IN} is adjacent to the original LCU 902 in the source frame IMG_{IN}. More specifically, encoding of the original LCU 902 is started after the original LCU 903 has been encoded. In this example, the original LCU 903 is located on the left side of the original LCU 902. However, this is for illustrative purposes only, and is not meant to be a limitation of the present invention. The original LCU 903 is assigned four first weighting parameters λ_{A}′, λ_{B}′, λ_{C}′, λ_{D}′ by the rate controller 128 for encoding (e.g., rate control) of four CUs in the original LCU 903, respectively. The decision logic 134 receives the first weighting parameters λ_{A}′, λ_{B}′, λ_{C}′, λ_{D}′ from the rate controller 128, and sets the second weighting parameter λ_{LCU} involved in making an SAO decision for the reconstructed LCU 901 by performing the λ selection operation F₂ upon the first weighting parameters λ_{A}′, λ_{B}′, λ_{C}′, λ_{D}′ i.e., λ_{LCU}=F₂(λ_{A}′, λ_{B}′, λ_{C}′, λ_{D}′). By way of example, but not limitation, the λ selection operation F₂ includes an arithmetic operation, wherein the arithmetic operation may include at least one of an addition operation, a subtraction operation, a maximum operation, a minimum operation, a mean operation, and a median operation.

As a person skilled in the art can readily understand details of remaining steps in the second method shown in FIG. 6 after reading above paragraphs, further description is omitted here for brevity.

Since the SAO decisions generated for different partial regions in the same frame are not based on a fixed weighting parameter, the decision logic 134 may generate a first SAO decision for pixels in a first partial region of a frame based at least partly on a cost function that uses one second weighting parameter derived from weighting parameter information given by a weighting parameter decision mechanism (e.g., a rate-distortion cost function that uses a Lagrange multiplier set by a first value given by a rate control mechanism), and generate a second SAO decision for pixels in a second partial region of the frame based at least partly on the cost function that uses another second weighting parameter derived from weighting parameter information given by the weighting parameter decision mechanism (e.g., the rate-distortion cost function that uses the Lagrange multiplier set by a second value given by the rate control mechanism and different from the first value), where the second partial region is different from the first partial region, and the used second weighting parameters are different from each other. To put it simply, when the encoder 100 encodes pixel data of different LCUs in one source frame by using quantization parameters determined by different Lagrange multiplier values, the Lagrange multiplier in the rate-distortion cost function used for making SAO decisions are modified in response to the different Lagrange multiplier values used in rate control. Hence, the coding efficiency can be improved due to reduced distortion between the original samples and the reconstructed samples.

As mentioned above, the decision logic 134 can generate an SAO decision for each partial region in a first frame according to the proposed SAO decision design shown in FIG. 2 or FIG. 6. In one exemplary embodiment, the decision logic 134 may be configured to generate an SAO decision for a second frame based on SAO decisions of a plurality of partial regions in the first frame, where the SAO decision generated for the second frame is an SAO on/off decision of the whole second frame. For example, when most of the SAO decisions generated for partial regions in the first frame indicate that the SAO should be turned off (i.e., SAO type=OFF), the SAO decision generated for the second frame by the decision logic 134 may indicate that SAO should be turned off for all partial regions in the second frame. For example, when the SAO filter 120 applies no SAO to most of the LCUs in a current reconstructed frame, the SAO filter 120 may turn off SAO for the next reconstructed frame.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling sample adaptive offset (SAO) filtering, comprising:
generating a first SAO decision for pixels in a first partial region of a first frame based at least partly on a cost function that uses a first weighting parameter; and
generating a second SAO decision for pixels in a second partial region of the first frame based at least partly on the cost function that uses a second weighting parameter;
wherein the second partial region is different from the first partial region, and the second weighting parameter is different from the first weighting parameter.

2. The method of claim 1, wherein each of the first partial region and the second partial region is a largest coding unit (LCU) of the first frame.

3. The method of claim 1, further comprising:
obtaining a specific quantization parameter (QP); and
determining the first weighting parameter according to the specific quantization parameter.

4. The method of claim 3, wherein obtaining the specific quantization parameter comprises:
setting the specific quantization parameter by a quantization parameter used for encoding all of a partial region of a source frame, wherein the first partial region of the first frame is a reconstructed partial region corresponding to the partial region of the source frame.

5. The method of claim 3, wherein obtaining the specific quantization parameter comprises:
setting the specific quantization parameter by performing a QP selection operation upon a plurality of quantization parameters, each used for encoding a portion of a partial region of a source frame, wherein the first partial region of the first frame is a reconstructed partial region corresponding to the partial region of the source frame.

6. The method of claim 3, wherein obtaining the specific quantization parameter comprises:
setting the specific quantization parameter by performing a QP selection operation upon a plurality of quantization parameters, each used for encoding a portion of a partial region of a source frame, wherein the first partial region of the first frame is a reconstructed partial region corresponding to another partial region of the source frame that is adjacent to the partial region of the source frame.

7. The method of claim 1, further comprising:
receiving at least one of the first weighting parameter and the second weighting parameter from a weighting parameter decision mechanism.

8. The method of claim 7, wherein the weighting parameter decision mechanism is a rate control mechanism.

9. The method of claim 1, wherein the cost function is a rate-distortion cost function, and the weighting parameter is a Lagrange multiplier of the rate-distortion cost function.

10. The method of claim 1, further comprising:
generating an SAO decision for a second frame based on SAO decisions of a plurality of partial regions in the first frame, wherein the partial regions comprise at least the first partial region and the second partial region.

11. The method of claim 10, wherein the SAO decision generated for the second frame is an SAO on/off decision of the whole second frame.

12. A method for controlling sample adaptive offset (SAO) filtering, comprising:
deriving a specific quantization parameter (QP) from at least one quantization parameter used for encoding pixels in a source frame;
determining a weighting parameter according to the specific quantization parameter; and
generating an SAO decision for pixels in a specific partial region of a first frame based at least partly on a cost function that uses the weighting parameter, wherein the first frame is a reconstructed frame corresponding to the source frame.

13. The method of claim 12, wherein the specific partial region is a largest coding unit (LCU) of the first frame.

14. The method of claim 12, wherein deriving the specific quantization parameter comprises:
setting the specific quantization parameter by a quantization parameter used for encoding all of a partial region of the source frame, wherein the specific partial region of the first frame is a reconstructed partial region corresponding to the partial region of the source frame.

15. The method of claim 12, wherein deriving the specific quantization parameter comprises:
setting the specific quantization parameter by performing a QP selection operation upon a plurality of quantization parameters, each used for encoding a portion of a partial region of the source frame, wherein the specific partial region of the first frame is a reconstructed partial region corresponding to the partial region of the source frame.

16. The method of claim 12, wherein deriving the specific quantization parameter comprises:
setting the specific quantization parameter by performing a QP selection operation upon a plurality of quantization parameters, each used for encoding a portion of a partial region of the source frame, wherein the specific partial region of the first frame is a reconstructed partial region corresponding to another partial region of the source frame that is adjacent to the partial region of the source frame.

17. The method of claim 12, wherein the cost function is a rate-distortion cost function, and the weighting parameter is a Lagrange multiplier of the rate-distortion cost function.

18. The method of claim 12, further comprising:
generating an SAO decision for a second frame based on SAO decisions of a plurality of partial regions in the first frame, wherein the partial regions comprise the specific partial region.

19. The method of claim 18, wherein the SAO decision generated for the second frame is an SAO on/off decision of the whole second frame.

20. A method for controlling sample adaptive offset (SAO) filtering, comprising:
deriving a second weighting parameter from at least one first weighting parameter, wherein the at least one first weighting parameter is associated with encoding of pixels in a partial region of a source frame, and is received from a weighting parameter decision mechanism; and
generating an SAO decision for pixels in a specific partial region of a first frame based at least partly on a cost function that uses the second weighting parameter, wherein the specific partial region of the first frame is a reconstructed partial region corresponding to the partial region of the source frame.

21. The method of claim 20, wherein the specific partial region is a largest coding unit (LCU) of the first frame.

22. The method of claim 20, wherein deriving the second weighting parameter comprises:
setting the second weighting parameter by a first weighting parameter used for encoding all of the partial region of the source frame, wherein the specific partial region of the first frame is a reconstructed partial region corresponding to the partial region of the source frame.

23. The method of claim 20, wherein deriving the second weighting parameter comprises:
setting the second weighting parameter by performing a weighting parameter selection operation upon a plurality of first weighting parameters, each used for encoding a portion of the partial region of the source frame, wherein the specific partial region of the first frame is a reconstructed partial region corresponding to the partial region of the source frame.

24. The method of claim 20, wherein deriving the second weighting parameter comprises:
setting the second weighting parameter by performing a weighting parameter selection operation upon a plurality of first weighting parameters, each used for encoding a portion of the partial region of the source frame, wherein the specific partial region of the first frame is a reconstructed partial region corresponding to another partial region of the source frame that is adjacent to the partial region of the source frame.

25. The method of claim 20, wherein the cost function is a rate-distortion cost function, and the second weighting parameter is a Lagrange multiplier of the rate-distortion cost function.

26. The method of claim 20, further comprising:
generating an SAO decision for a second frame based on SAO decisions of a plurality of partial regions in the first frame, wherein the partial regions comprise the specific partial region.

27. The method of claim 26, wherein the SAO decision generated for the second frame is an SAO on/off decision of the whole second frame.

28. The method of claim 20, wherein the weighting parameter decision mechanism is a rate control mechanism.

29. A sample adaptive offset (SAO) filter, comprising:
a filter, configured to operate in response to each SAO decision; and
a decision logic, configured to generate a first SAO decision for pixels in a first partial region of a first frame based at least partly on a cost function that uses a first weighting parameter; and generate a second SAO decision for pixels in a second partial region of the first frame based at least partly on the cost function that uses a second weighting parameter;
wherein the second partial region is different from the first partial region, and the second weighting parameter is different from the first weighting parameter.

30. A sample adaptive offset (SAO) filter, comprising:
a filter, configured to operate in response to each SAO decision; and
a decision logic, configured to derive a specific quantization parameter (QP) from at least one quantization parameter used for encoding pixels in a source frame, determine a weighting parameter according to the specific quantization parameter, and generate an SAO decision for pixels in a specific partial region of a first frame based at least partly on a cost function that uses the weighting parameter, wherein the first frame is a reconstructed frame corresponding to the source frame.

31. A sample adaptive offset (SAO) filter, comprising:
a filter, configured to operate in response to each SAO decision; and
a decision logic, configured to:
derive a second weighting parameter from at least one first weighting parameter, wherein the at least one first weighting parameter is associated with encoding of pixels in a partial region of a source frame, and is received from a weighting parameter decision mechanism; and
generate an SAO decision for pixels in a specific partial region of a first frame based at least partly on a cost function that uses the second weighting parameter, wherein the specific partial region of the first frame is a reconstructed partial region corresponding to the partial region of the source frame.
